(19) United States
(12) Patent Application Publication
(10) Pub. No.: US 2002/0093492 A1
(43) Pub. Date: Jul. 18, 2002

(54) System for a navigable display

(76) Inventor: John M. Baron, Longmont, CO (US)

Correspondence Address: HEWLETT-PACKARD COMPANY, Intellectual Property Administration, P.O. Box 272400, Fort Collins, CO, 80527-2400, US

(21) Appl. No.: 09/765,172

(22) Filed: Jan. 18, 2001

(51) Int. Cl. G09G 5/00

(52) U.S. Cl. 345/173

(57) ABSTRACT

A portable handheld device, such as a camera, is provided. The device comprises a functional unit and an associated electronic control system. The control system includes a flat panel display for providing a visual display used to control the functional unit. The electronic control system also comprises a switch platform mounted to detect a touching about a periphery of the display to provide a plurality of discrete output signals which are each indicative of a portion of the periphery in which the touching is detected. A user may navigate through information on the visual display by touching the display to activate the switches in a manner which moves a cursor through items depicted on the display.

### BACKGROUND

Visual displays have been used to communicate status and other information to users for many years on many different devices. For example, digital clocks and car stereos have a digital display which communicates to a user information such as the time of day, radio frequency being received, or audio volume level. These displays typically only communicate information to a user and do not allow the user to interact with the information on the display. Specifically, for example, in response to displayed information regarding the device's status a user is generally required to manipulate dials or buttons on the device's functional unit to change the parameters, settings or status of the device. The display typically changes as the device's parameters change in response to the user's input. In other words, the changes to the parameters of the device which are carried out by manipulation of the dials or buttons are reflected on the display which typically depicts only the current status of the device.

More recently, visual displays in the form of flat panel displays, such as liquid crystal displays (LCDs), have been used in connection with a multitude of products such as laptop computers, personal digital assistant (PDAs), cellular phones, pagers, camcorders, cameras, etc. In addition to communicating information, these displays often prompt a user to perform a function, select an entry, choose an item off a pick list, or otherwise interact with the information.

In responding to a query or prompt from the display, or in seeking to navigate through information on the display to acquire or select specific information, or to otherwise select a function, the user must use a keyboard, command keys, or other user input mechanism which are separate or remote from the display. One drawback of having a separate user-input platform is that the platform takes up significant space on the device or requires a remote platform to be used in conjunction with the device. As will be appreciated by one of ordinary skill in the art, providing a remote platform for user input may be disadvantageous because it makes the device less portable, requires additional software, and often prevents the device from being operable by itself. Likewise, as will be appreciated by one of ordinary skill in the art, providing a user input platform on a device may be disadvantageous because it may require the device to be sized much larger than desired (generally, each user input must be large enough to accommodate a human finger for activating the button or key), and often requires multiple user inputs to be provided on the device in order to allow a user to effectively navigate through information on a display.

In an effort to minimize the area on a device required for user inputs, the art has developed a cruciform key which allows a user to move a cursor in an up, down, right, or left direction using a single key. One drawback of this type of key is that it does not allow a user to navigate in angular directions (i.e. up and right at the same time) and does not perform a function if the user presses the center of the key. As will be appreciated by one of ordinary skill in the art, cruciform keys typically do not allow more than one of the switches disposed under the arms of the key to be activated at the same time.

In another effort to minimize the area associated with user inputs, and in an effort to allow navigation of a display beyond the typical unidirectional command keys, the art has developed “touch-screen” displays. There are a number of different types of touch screens that operate in different ways. However, as will be appreciated by one of ordinary skill in the art, a major drawback of touch-screen technology is its sophistication and expense. Touch screen technology requires sophisticated sensing equipment or software to be associated with the screen to register the commands of the user. This sophistication is too elaborate for many simple devices and cost prohibitive for most devices.

The foregoing underscores some of the problems associated with navigating visual displays on devices. Furthermore, the foregoing highlights the need for an inexpensive navigational system which does not require a large user-input area beyond that of the area occupied by the display.

### SUMMARY OF THE INVENTION

The present invention overcomes many of the practical problems described above and offers new advantages as well. The present invention is based, in part, on the provision of navigational switches in an area associated with the display. Associating switches with the display allows a frame of the display, or the display itself, to serve as command keys or user inputs. As will be appreciated by one of ordinary skill in the art, the present invention may render the provision of separate, distinct user input keys unnecessary for a device and may avoid the added expense that would be necessary to provide touch-screen technology to a device.

Accordingly, it is an object of the invention to provide a device having a display having at least one navigational switch associated therewith. It is a related object of the invention to provide a device having a display which is associated with at least one navigational switch, wherein a user touches or depresses said display to activate said switch.

It is also a related object of the invention to provide a device having a display which is associated with a plurality of switches, wherein a user can activate any and/or all of said switches by selective contact with a portion or portions of said display which are designated to activate one or more of said switches.

According to one aspect of the invention, the device comprises pressure sensitive switches mounted in proximity to respective edges of a flat panel display and configured so that said touching about the periphery of the display at an intersection of two of the edges operates a corresponding one of the switches and touching at a mid-point of one of the edges operates a corresponding pair of said switches.

According to another aspect in the invention, the flat panel display is mounted on a switch platform which includes pressure sensitive switches positioned to detect pressure applied proximate respective edges of said flat panel display.

According to a related aspect in the invention, the device further comprises a pressure sensitive switch positioned to detect a pressure applied to a central portion of a flat panel display.

In a presently preferred embodiment, the flat panel display is a rectangular shaped liquid crystal display device. Although a rectangular shape is presently preferred, any suitable shape may be used with the present invention. Accordingly, the invention should not be viewed as limited by the shape of the display. Furthermore, although a liquid crystal display is a presently preferred display, any suitable display may be used with the present invention. Accordingly, the invention should not be viewed as limited by the display employed with the invention.

In accordance with another preferred embodiment, the electronic control system is configured to cause the flat panel display to display a value of a control parameter and to detect an operation of the switch platform to change the value. In an alternative embodiment, the electronic control system is configured to cause the flat panel display to display a value of a control parameter and to detect an operation of said switch platform to selectively increment and decrement the value and to select said value.

In accordance with yet another aspect of the invention, the functional unit comprises an optical imaging device, and preferably comprises an optical imaging device including an optical system configured to project an image onto a light sensitive media, and more preferably, comprises a camera.

It is another object of the invention to provide devices of the type described above, wherein the device has a frame surrounding at least a portion of the display, wherein a user contacts the frame to activate the switch or switches disposed on the periphery of the display.

Additional objects of the invention may be realized by providing display devices of the type described above, wherein said switch platform comprises a plurality of electrical switches mounted at the corners and/or adjacent respective edges of said flat panel display and a frame mounted to said switches, said frame surrounding said flat panel display, said frame and switches configured to detect a pressure applied proximate respective corners and/or edges of said flat panel display. The devices may be incorporated into suitable fixed or portable systems, and included in a suitable housing which may be stationary or portable and, preferably, capable of being handheld.

Further objects of the invention may be realized by providing devices having said frame mounted to said switches, and having a pressure sensitive switch positioned to detect a pressure applied to a central portion of said flat panel display.

In accordance with one aspect of the invention, the functional unit comprises an optical imaging device, preferably said optical imaging device includes an optical system configured to project an image onto a light sensitive media. More preferably, the functional unit comprises a camera.

In accordance with one aspect of the invention, an imaging platform comprises an array of electronic photodetectors. According to another aspect of the invention, the imaging platform comprises a film transport configured to position a light sensitive media such that said image is projected onto said light sensitive media causing a corresponding latent image to be created on said light sensitive media.

In accordance with yet another aspect in the invention, the switch platform preferably comprises a plurality of electrical switches or pressure transducers mounted adjacent corners and/or respective edges of said flat panel display and a frame mounted to said switches, said frame surrounding said flat panel display, said frame and switches configured to detect a pressure applied approximate respective corners and/or edges of said flat panel display. More preferably, the camera further comprises a pressure sensitive switch or pressure transducer positioned to detect a pressure applied to a central portion of said flat panel display. Alternatively, other forms of sensors may be used to detect a touching of particular areas of the display and/or surrounding frame, e.g., capacitive or light sensors, etc.

In accordance with another aspect of the invention, the flat panel display is configured to sequentially display a plurality of parameters in response to respective activations of left and right portions of said switch platform, increase and decrease a value associated with a displayed one of said parameters in response to activations of top and bottom portions of said switch platform, and select a displayed one of said values in response to a touching of a central portion of said flat panel display.

According to one aspect of the invention, the display device allows a user to navigate a menu system. According to another aspect of the invention, the display device allows a user to position a cursor on the display. In accordance with one embodiment, the display panel includes left, right, top and bottom edges, said frame comprising corresponding left, right, top and bottom portions whereby a pressure applied to said left and right portions of said frame causes activation of respective pairs of switches and respective reverse and forward scrolling through said parameters and a pressure applied to said top and bottom portions of said frame causes activation of other pairs of switches and respective forward and reverse scrolling through values associated with a selected one of said parameters. In accordance with an alternative embodiment, selective activation of said switches allows a user to control the position, direction and/or speed of movement of a cursor depicted on the display.

According to yet another aspect of the invention, the frame is positioned peripheral to said display panel. In accordance with another object of the invention, there are disclosed methods of using the aforementioned devices.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, reference is now made to the following descriptions taken in conjunction with the accompanying drawings, in which:

FIG. 1 is a back view of an embodiment of a camera having a navigable display according to the invention;

FIG. 2 is a plan view of the underside of an alternate embodiment of a navigable display according to the invention;

FIG. 3 is a side view of the display of FIG. 2 taken along line 3-3;

FIG. 4 is a side view of the display of FIG. 2 taken along line 4-4;

FIG. 5 is a plan view of the underside of another alternate embodiment of a navigable display according to the invention;

FIG. 6 is a side view of the display of FIG. 5 taken along line 6-6;

FIG. 7 is a side view of the display of FIG. 5 taken along line 7-7;

FIG. 8 is a block diagram of a 35 mm camera embodiment of the invention; and

FIG. 9 is a block diagram of a digital camera embodiment of the invention.

### DETAILED DESCRIPTION

Generally, the present invention relates to a switch platform for allowing a user to interact with a display. The switch platform may be used in connection with any suitable display unit and may be used with any suitable functional unit. As will be appreciated by one of ordinary skill in the art armed with the present application, almost any display, including liquid crystal displays (LCDs) and cathode ray tube (CRT) displays, may be made navigable according to the invention. Likewise, as will be appreciated by one of ordinary skill in the art, almost any functional unit capable of using a visual display may be suitable for use with a navigable display according to the invention. For example, portable or handheld devices, such as cameras or video recorders and stationary devices, such as ATM machines or car stereos, may both profit from the provision of a navigable display associated with the device. In a presently preferred embodiment, the display is used in connection with a camera serving as the functional unit.

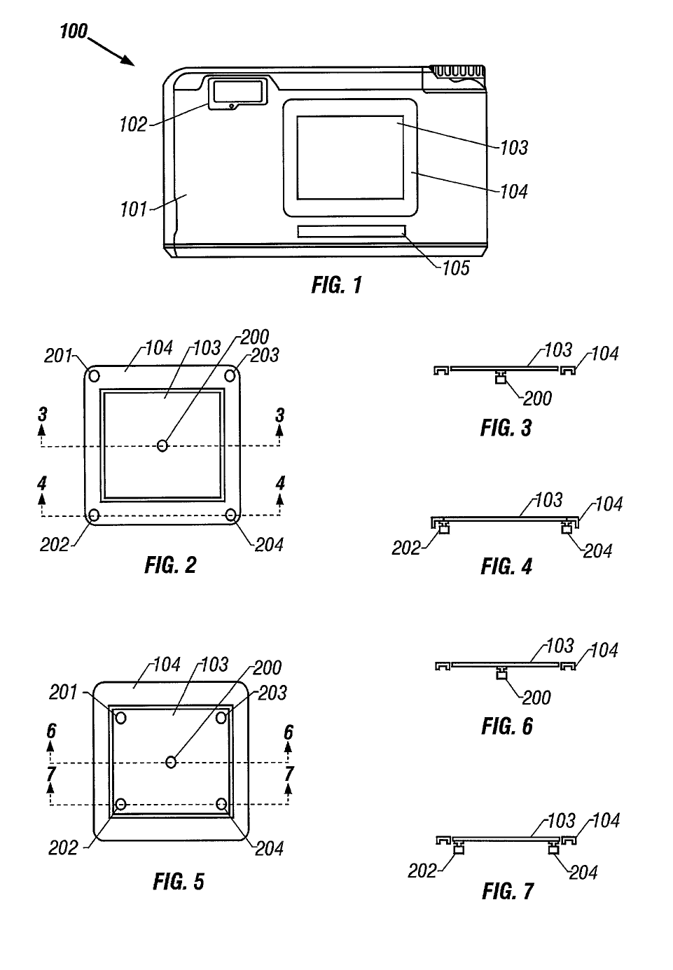

FIG. 1 depicts back 101 of camera 100 according to the invention. Camera back 101 has view finder 102, or eye piece, through which a user looks to preview the image to be captured on the camera's film (not shown) or digitized and stored. Also, disposed on camera back 101 is display 103.

Display 103 is preferably a liquid crystal display (LCD), or other suitable display, adapted for displaying menus and pick lists of selection options, control parameters, functional unit settings, lists or arrays of images, and the like. Accordingly, the invention should not be viewed as limited by the type of display utilized and the information presented on the display.

In the embodiment depicted in FIG. 1, display 103 is surrounded on its periphery by frame 104. In this embodiment, located in an area beneath display 103 on camera back 101 is an enter or select button 105.

Although not shown in FIG. 1, in contact with an underside of display 103, or alternatively the underside of frame 104, are a plurality of switches (best shown in FIGS. 2-7). The switches may provide a mounting for display 103, or alternatively, may be incorporated into, or otherwise provide support for, frame 104.

Any suitable switch may be used with the present invention. In a presently preferred embodiment, the switches are mechanical electrical switches, wherein applying pressure to the switch causes contacts within the switch to be brought into contact with each other, thereby completing an electrical circuit through the switch. Alternative switches suitable for use with the present invention include other pressure sensitive switches such as piezoelectric sensors and the like. Accordingly, the invention should not be viewed as limited by the switches exemplified herein.

The switches may be disposed at any operative location. Preferable, four switches will be operatively disposed around the periphery of display 103 or frame 104. In accordance with one embodiment, display 103 and/or frame 104 are generally square or rectangular in shape. In this embodiment, the switches are positioned adjacent respective corners of display's 103 periphery or frame's 104 periphery.

As will be appreciated by one of ordinary skill in the art, in an embodiment where a switch is disposed proximate or at the corners of each side of the four sides of display 103 or frame 104, a user can activate a pair of switches by pressing the appropriate edge of the display 103 or frame 104 along an edge joining the corners or may activate a single switch by pressing the appropriate corner. Thus, for example, by touching the top or bottom of display 103 or frame 104, a user can cause a cursor or prompt on the display to move up or down through the information depicted on the display. Likewise, by touching the left or right edge of the display or frame, a user can activate pairs of the corner switches and, for example, cause a cursor to move to the right or left, or alternatively, to execute other commands.

The embodiment in FIG. 1 may have a switch platform having switches residing along the mid-riff of the edges of the display 103 or frame 104. With such a configuration, the switches may provide commands for four cursor directions for navigating through information on the display; namely, up, down, right and left. However, the system requires a method for allowing a user to select information or otherwise acknowledge that the cursor or prompt is in an appropriate location. In the embodiment in FIG. 1, camera 100 uses the enter or select button 105 to accomplish this function. Alternatively, the system may be configured to allow a user to touch a center section of the display to cause the engagement of all of the switches thereby indicating to the device that the user wishes to select or choose the highlighted selection.

In an alternative embodiment, the switch platform has a switch disposed underneath the center area of the display 103. Preferably, the switch operates as an enter or select button, whereby a user desiring to select or choose a highlighted entry on display 103 can do so by pressing the center of the display 103. Accordingly, enter or select button 105 may not be needed, or alternatively assigned a different function.

In the embodiment having switches in a plus or cross pattern, the number of commands may be unnecessarily limited to four, one command for each edge of the display or frame touched. In a presently preferred or alternative embodiment, the switches are disposed in the four corners of the display as depicted in FIG. 5, or disposed in the four corners of the frame as depicted in FIG. 2. As will be appreciated by one of ordinary skill in the art, such a configuration provides a user with at least eight or nine different commands. To illustrate, a user could activate different switches and communicate different commands by pressing:

1. The top left corner to activate the top left corner switch 201;

2. The bottom left corner to activate the bottom left corner switch 202;

3. The left side to activate both the top left 201 and bottom left 202 switches;

4. The top right corner to activate the top right corner switch 203;

5. The bottom right corner to activate the bottom right corner switch 204;

6. The right side to activate both the top right 203 and the bottom right 204 switches;

7. The top side to activate both the top left 201 and top right 203 switches;

8. The bottom side to activate both the bottom left 202 and bottom right 204 switches; or

9. The center to activate all four switches 201, 202, 203, 204 or alternatively, to activate a center switch 200 disposed under the center of the display.

FIG. 2 depicts an embodiment making use of corner switches, wherein the corner switches are disposed on the corners of the frame surrounding the display. In the embodiment depicted in FIG. 2, the switch platform also includes a center switch 200. FIG. 3 shows a side view of the embodiment of FIG. 2 taken along line 3-3. As depicted, center switch 200 provides a mount for the display 103, wherein pressure exerted by a user overcomes the bias of the switch mount and allows the switch to be compressed and activated as previously described. FIG. 4 shows a side view of the embodiment of FIG. 2 taken along line 4-4. As depicted, corner switches 202, 204 (in conjunction with corner switches 201, 203 not visible on FIG. 4) provide a mount for the frame and may also be selectively activated by a user rocking the frame by exerting pressure in an appropriate area to overcome the bias of one or more of the switches.

FIG. 5 depicts an embodiment making use of corner switches, wherein the corner switches are disposed on the corners of the display itself. In the embodiment depicted in FIG. 5, the switch platform also includes a center switch 200. FIG. 6 shows a side view of the embodiment of FIG. 5 taken along line 6-6. As depicted, center switch 200 provides a mount for display 103 and operates as described in connection with FIGS. 2 and 3. Likewise, FIG. 7 shows a side view of the embodiment of FIG. 5 taken along line 7-7. As depicted, corner switches 202, 204 (and 201, 203 not shown) operate in a manner similar to that described in connection with FIGS. 2 and 4. The only difference, is that the switches are activated by rocking of the display as opposed to the frame.

In the embodiment shown in FIG. 5, display 103 is surrounded by frame 104. In this embodiment, frame 104 may be for aesthetic purposes or to protect the display during rocking. Alternatively, frame 104 may cooperate with additional switches which may serve additional functions. For example, the additional switches may provide different discrete outputs to instruct the functional unit to perform different functions, or alternatively, the switches may serve to accentuate the speed of the adjacent switches associated with the display.

In operation, a user of camera 100 seeks status information about camera 100, or seeks to select parameters, settings, or like options for use with camera 100. The user views information displayed on display 103. If the user needs to navigate through information on display 103, the user uses the navigable display. For example, the user may manipulate a cursor or prompt to scroll through items on a pick list by pressing the top or bottom edge of display 103 or frame 104. When the appropriate item is highlighted, the user may press the center of display 103 to activate central switch 200 which acts as an enter or select key. Likewise, if the user needs to scroll through sub-options of the highlighted item, the user may manipulate a cursor or prompt to enter sub-menus by pressing the left or right side of display 103 or frame 104. Once an appropriate item is highlighted, the user presses the center of display 103 to activate central switch 200 which acts as an enter or select key.

After being selected, the item may require additional selections to be made by the user. Additional pick lists or other query screens may be displayed which can be navigated by manipulation of the various switches disposed around display 103 or frame 104. For example, by use of the navigable display a user may be able to select an option to modify or set shutter speed, lens aperture, film speed, or other parameters of the camera 100. The user may also select a parameter to be modified and then use the display to increase, decrease, or otherwise set the desired value for that setting. Additionally, the navigable display may be used to inform the user of the status of the camera or allow the user to command the camera to perform other functions such as rewind, flash on/off, etc.

Once the desired parameters are set, the user may peer through the eye piece 102 to preview the image to be captured and then snap the photograph.

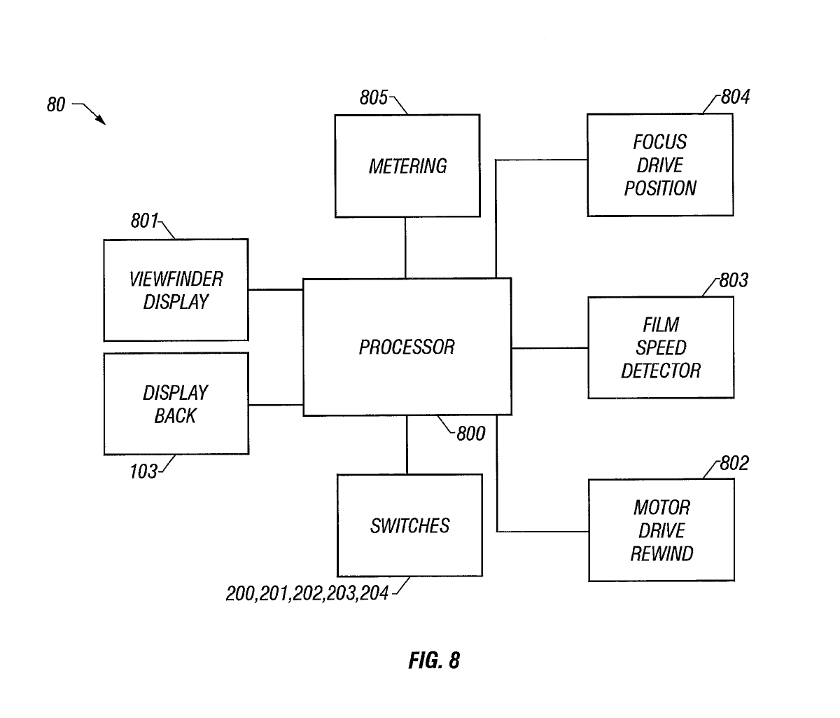

FIG. 8 depicts block diagram 80 of camera 100 (for use with film) according to the invention. Camera 100 has processor 800 for processing information and generally controlling the operation of the camera. In communication with processor 800 are switches 200, 201, 202, 203, 204 of display 103. Also, in communication with processor 800 is a viewfinder display 801 which displays information from processor 800 to a user peering through viewfinder 102. Processor 800 also communicates with, and controls in response to user input, motor drive/rewind motor(s) 802, a film speed detector 803, a focus drive position sensor 804 and metering sensor 805. As will be appreciated by one of ordinary skill in the art, these camera functions and parameter controls communicate with processor 800 which provides status and parameter information to the user via display back 103 so that a user can navigate display 103 by actuating switches 200, 201, 202, 203, 204 in a manner that allows the user to instruct processor 800 to manipulate these controls in a desired way.

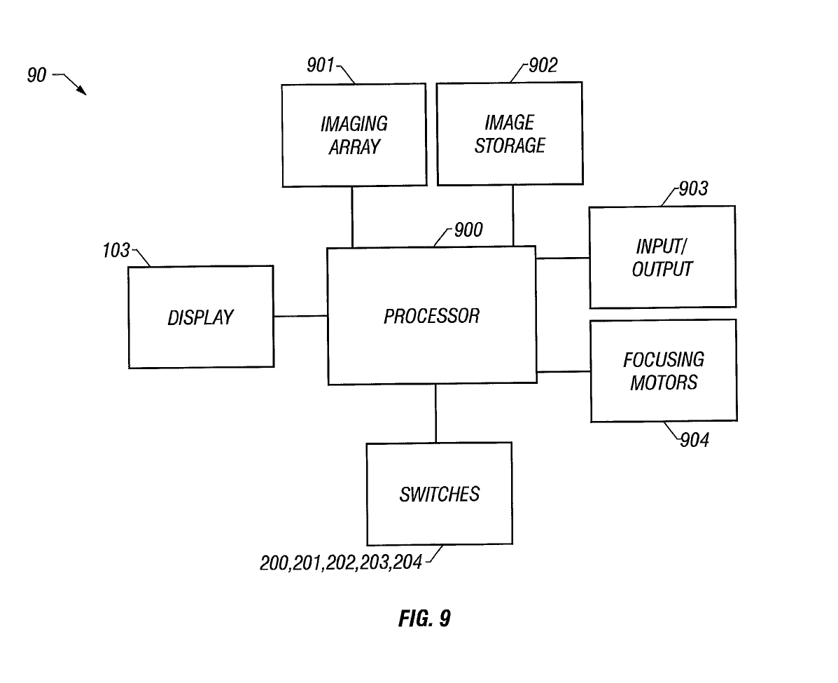

FIG. 9 depicts block diagram 90 of a digital camera according to the invention. The camera has processor 900 in communication with switches 200, 201, 202, 203, 204 and display 103 in analogous manner as that described in connection with FIG. 8. Likewise, the processor 900 is also in communication with imaging array 901 and image storage 902 for capturing and storing an image. Also, in communication with processor 900 are input/output controller 903 and focusing motor 904. As will be appreciated by one of ordinary skill in the art, this and like configurations allow a user to receive information from these controls via display 103 and allows a user to interact with the information via switches 200, 201, 202, 203, 204 to instruct processor 900 to manipulate these controls in a desired way.

While the present invention is described in connection with a camera having a navigable display, it will be readily appreciated by one of ordinary skill in the art that the teachings of the present invention can be applied to any suitable device making use of a display which requires or allows a user to navigate its contents. Accordingly, the invention should not be viewed as limited to specific devices, displays, or environments.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A display for use in controlling the execution of a functional device, said display comprising;
an electronic control system housed in association with said display, said electronic control system including a switch platform mounted to detect a touching about a periphery of said display and to provide a plurality of discrete output signals each indicative of a portion of said periphery at which said touching is detected.

2. The display of claim 1 wherein said display is a flat panel display.

3. The display according to claim 1 wherein:
said functional device comprises an optical imaging device.

4. The display device according to claim 3 wherein said optical imaging device includes an optical system configured to project an image onto a light sensitive media.

5. The display according to claim 2 wherein said switch platform comprises pressure sensitive switches mounted in proximity to respective edges of said display and configured so that touching at a corner operates a corresponding one of said switches and touching at a midpoint of one of said edges operates a corresponding pair of said switches.

6. The display according to claim 1 wherein said display is mounted on said switch platform, said switch platform, which, in turn, is mounted on an enclosure, wherein said enclosure encompasses at least a portion of said functional device, and said switch platform including pressure sensitive switches positioned to detect pressure applied proximate respective corners of said display.

7. The display according to claim 6 further comprising a pressure sensitive switch positioned to detect pressure applied to a central portion of said display.

8. The display device according to claim 1 wherein said switch platform comprises a plurality of electrical switches mounted adjacent respective edges of said display and a frame mounted to said switches, said frame surrounding said display, said frame and switches configured to detect pressure applied proximate respective corners of said flat panel display.

9. The device according to claim 8 further comprising a pressure sensitive switch positioned to detect pressure applied to a central portion of said display.

10. The display according to claim 1 wherein said display is a rectangular shaped liquid crystal display device.

11. The display device according to claim 2 wherein said electronic control system is configured to cause said display to display a value of a control parameter and to detect an operation of said switch platform to change said value.

12. The display device according to claim 1 wherein said electronic control system is configured to allow a user to selectively position a cursor or said display.

13. A camera comprising:
an optical system configured to project an image onto an imaging platform;
a controller configured to control an operation of said optical system;
a display operable to provide a visual display of parameter values used in conjunction with said optical system; and
a switch platform configured to provide control signals to said controller for selecting said parameter values, said switch platform mounted to detect a touching about a periphery of said display and operational for providing a plurality of discrete output signals to said controller, each indicative of a portion of said periphery at which said touching is detected.

14. The camera according to claim 13 wherein said display is a flat panel display.

15. The camera according to claim 13 wherein said switch platform comprises a plurality of electrical switches mounted adjacent respective edges of said display and a frame mounted to said switches, said frame surrounding said display, said frame and switches configured to detect pressure applied proximate respective edges of said flat panel display.

16. The camera according to claim 15 further comprising a pressure sensitive switch positioned to detect pressure applied to a central portion of said flat panel display.

17. The camera according to claim 13 wherein said display is configured to sequentially display a plurality of parameters in response to respective activations of left and right portions of said switch platform, increase and decrease a value associated with a displayed one of said parameters in response to activations of top and bottom portions of said switch platform, and select a displayed one of said values in response to a touching of a central portion of said flat panel display.

18. An operator interface device comprising:
a display panel operable to provide a visual display indicative of a parameter to be controlled and values associated with respective ones of said parameters;
a first discrete electrical switch operable to select a displayed value in response to a touching of a cental portion of said display panel;
an array of discrete pressure sensitive electrical switches positioned adjacent respective edges of said display panel; and
a frame attached to said array of pressure sensitive electrical switches and configured whereby a pressure applied to a portion of said frame adjacent a respective edge of said display panel causes an activation of a corresponding one of said switches.

19. The operator interface device according to claim 18 wherein said display panel includes left, right, top and bottom edges, said frame comprising corresponding left, right, top and bottom portions whereby a pressure applied to said left and right portions of said frame causes respective reverse and forward scrolling through said parameters and a pressure applied to said top and bottom portions of said frame causes respective forward and reverse scrolling through values associated with a selected one of said parameters.

20. The operator interface device according to claim 18 wherein said frame is positioned peripheral to said display panel.
